(19) United States
(12) Patent Application Publication
(10) Pub. No.: US 2018/0108081 A1
(43) Pub. Date: Apr. 19, 2018

(54) VIRTUAL SYSTEM FOR SEEING A PROPERTY

(71) Applicant: WAN-LIN SUN, Changhua County (TW)

(72) Inventor: WAN-LIN SUN, Changhua County (TW)

(21) Appl. No.: 15/846,154

(22) Filed: Dec. 18, 2017

Related U.S. Application Data
(63) Continuation-in-part of application No. 15/140,148, filed on Apr. 27, 2016.

(51) Int. Cl. G06Q 30/06; G06T 19/00; G06T 17/05; G06T 15/50

(52) U.S. Cl. CPC G06Q 30/0643; G06T 15/50; G06T 17/05; G06T 19/003

(57) ABSTRACT

A virtual system for seeing a house includes an output module for showing text, picture, and video information of the house; a storage module for storing an outdoor view model and an indoor view model; each indoor view model includes a passage open onto the outdoor view model for intercommunicating the indoor view model and the outdoor view model; an input module for inputting commands; and a processing module for reading data from both the outdoor and indoor view models to continuously and sequentially show an outdoor view screen and an indoor view screen on the output module or vice versa. Therefore, the virtual system enables an interested buyer to walk freely inside or outside the house and fully understand both indoor and outdoor details of the house without visiting the house in person. The virtual system further includes a virtual buyer which can be manipulated by the interested buyer to stimulate the walking inside or outside the house in a first person perspective, checking if there is any blind spots existing.

### BACKGROUND OF THE INVENTION

### 1. Technical Field

The invention relates to systems for seeing a property and more particularly to a virtual system for enabling an interested buyer to see a house.

### 2. Related Art

The need to buy a property and/or renting an apartment is great due to population explosion. Technologies for enabling people to find a suitable property by not visiting it have been developed.

Early technology involves posting photographs of houses on a real estate website for viewing, i.e., the technology being a virtual system for enabling an interested buyer to see a house prior to buying. However, these photographs are two-dimensional (2D) plan views and unable to provide three-dimensional (3D) (i.e., perspective) views of houses for viewing. Thus, interested buyers cannot understand internal details of a house. A quick decision of buying the house by a potential buyer is not possible.

Recently, as disclosed by the U.S. Patent Application Publication No. 2010/0312670, Dempsey, real estate agents used digital camera to take photographs in a house and posted the 3D video clips on the website for viewing. While such method has above advantages, the 3D video clips have its limitations when playing. For example, it is played in a predetermined format and sequence, it cannot be rotated, and details of the house cannot be seen. The user can only see the house in some predetermined angles, normally in a predetermined path in the house. Therefore, an interested buyer still cannot understand internal details of the house. Further, it is difficult of understanding whether people may collide when walking in the house by viewing the video clips. Furthermore, environment surrounding a property is also a factor affecting an individual's decision of buying the property or not. Therefore, information of the surrounding environment and location of the house in a city should be available. However, the typical technology of enabling people to see a property without visiting it does not have above desired functions. As disclosed by the U.S. Patent Application Publication No. 2008/0252640 A1, Williams, even though a buyer can see the exterior of the house from outside of the house, the exterior looks of the house is still part of the 3D indoor view model, and there is no any 3D outdoor view model (surrounding of the house, like street, traffic, natural landscape, etc.) is established for a user to directly walk into from the indoor view model. Thus, the need for improvement still exists.

### BRIEF SUMMARY

It is therefore one object of the invention to provide a virtual system for seeing inside and outside of a property. The virtual system comprising an output module for presentation of images, text, video, and audio transmitted electronically; an input module for inputting commands; an outdoor view model, stored as an outdoor view 3D model compressed file; an indoor view model, stored as an indoor view 3D model compressed file; a passage, stored as a passage 3D model compressed file; a storage module, wherein the outdoor view 3D model compressed file, the indoor view 3D model compressed file, and the passage 3D model compressed file are integrated to be stored in the storage module; the indoor view model being disposed inside the outdoor view model; the passage being disposed in the indoor view model and intercommunicating the indoor view model and the outdoor view module; a processing module for reading and executing the indoor view model, the outdoor view model, and the passage, and the indoor view model, the outdoor view model, and the passage being shown by the output module; the processing module executing an input command from the input module to demonstrate a continuous motion image or a static image of the outdoor view model, the indoor view model, or the passage, such that a user can enter inside of the indoor view model from the outdoor view model through the passage, or enter into the outdoor view model from the indoor view model through the passage.

Preferably, the compressed files are FBX files.

Preferably, size information of the outdoor view model, the indoor view model, and the passage are constructed as three dimensional models (3D models), and those 3D models are further compressed by means of a 3D image compression technology to store material, size, scale of those 3D models as scene nodes, and different types of data will be stored as virtual node by organizing the data in tree structure.

Preferably, the virtual system further comprises a virtual buyer, the virtual buyer is stored in the storage module in a 3D model compressed FBX file format, and is integrated with the outdoor view model, the indoor view model, and the passage.

Preferably, the processing module reads and executes the input command from the input module to move the virtual buyer from the indoor view model via the passage to the outdoor view model, and the virtual buyer is able to observe an image of the outdoor view model in first-person perspective, as well as realizing landscape surrounding the indoor view model.

Preferably, the processing module reads and executes the input command from the input module to move the virtual buyer, and the virtual buyer is able to move between the outdoor view model and the indoor view model in a continuous motion way.

Preferably, the virtual buyer moves in the 3D model according to the following formula:

rb.MovePosition(transform.position+transform.forward*Time.deltaTime).

Preferably, a virtual light source is further provided for simulating sunlight or moonlight wherein the virtual light source is stored in the storage module, the processing module is configured to read data from the storage module to access the virtual light source, and the processing module is configured to move the virtual light source which is configured to emit light onto the outdoor view model, and the light is configured to illuminate the indoor view model through the passage.

Preferably, the virtual system further comprises a virtual light source for simulating sunlight or moonlight wherein the virtual light source is stored in the storage module, the processing module is configured to read data from the storage module to access the virtual light source, and the processing module is configured to move the virtual light source which is configured to emit light onto the outdoor view model, and the light is configured to illuminate the indoor view model through the passage.

Therefore, it can be known that the virtual system of the present invention can enable an interested buyer to walk freely inside or outside the house and fully understand both indoor and outdoor details of the house without visiting the house in person. The virtual system further includes a virtual buyer which can be manipulated by the interested buyer to stimulate the walking inside or outside the house in a first person perspective, checking if there is any blind spots existing, and thus the potential buyer can quickly make a decision if renting or buying the property.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a virtual system for seeing a property according to a first preferred embodiment of the invention;

FIG. 2 is a top view of an outdoor view screen;

FIG. 3 is a detailed view of the area in a circle of FIG. 2;

FIG. 4 is a perspective view of an indoor view screen;

FIG. 5 is a block diagram of a virtual system for seeing a property according to a second preferred embodiment of the invention;

FIG. 6 is a top view of an outdoor view screen showing an operation thereof; and

FIG. 7 is a perspective view of an indoor view screen showing an operation thereof.

### DETAILED DESCRIPTION

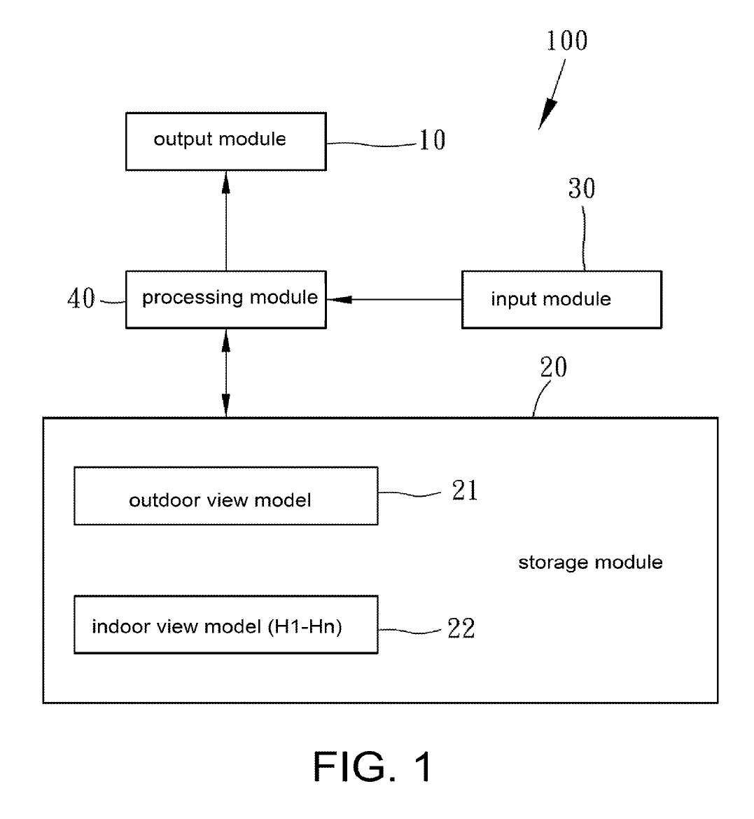

Referring to FIGS. 1 to 4, a virtual system 100 for enabling an interested buyer to see a house prior to buying in accordance with a first preferred embodiment of the invention comprises the following components as discussed in detail below.

An output module 10 is for presentation of images, text, video and audio transmitted electronically and it can be implemented as a liquid-crystal display (LCD) screen, a touch screen, or a wearable device such as an optical head-mount display.

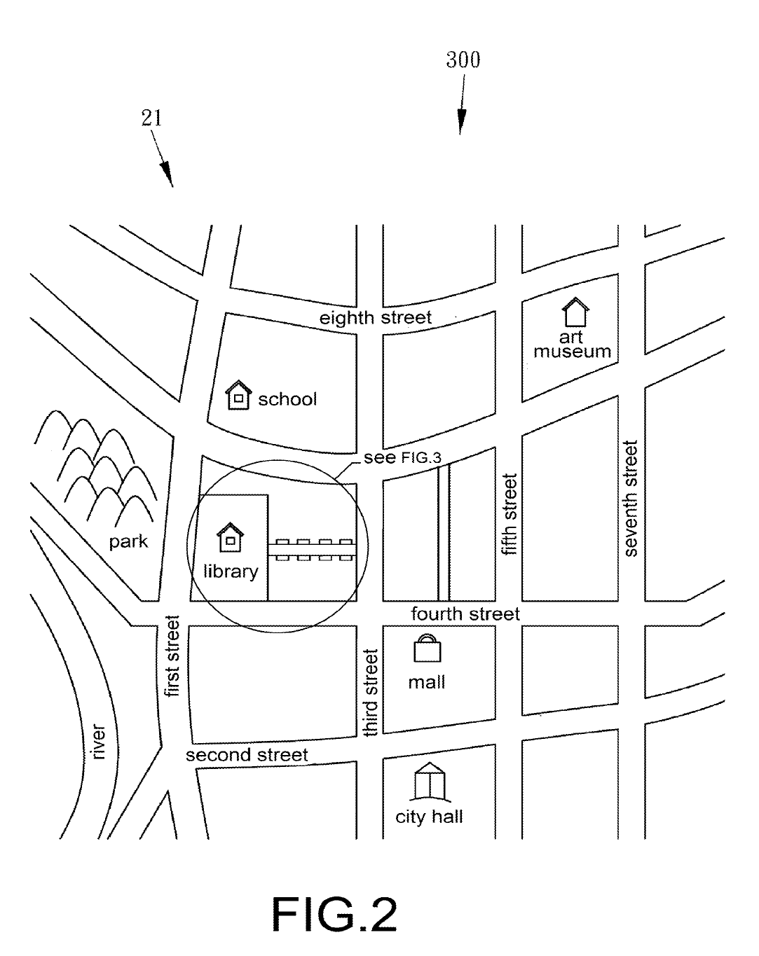

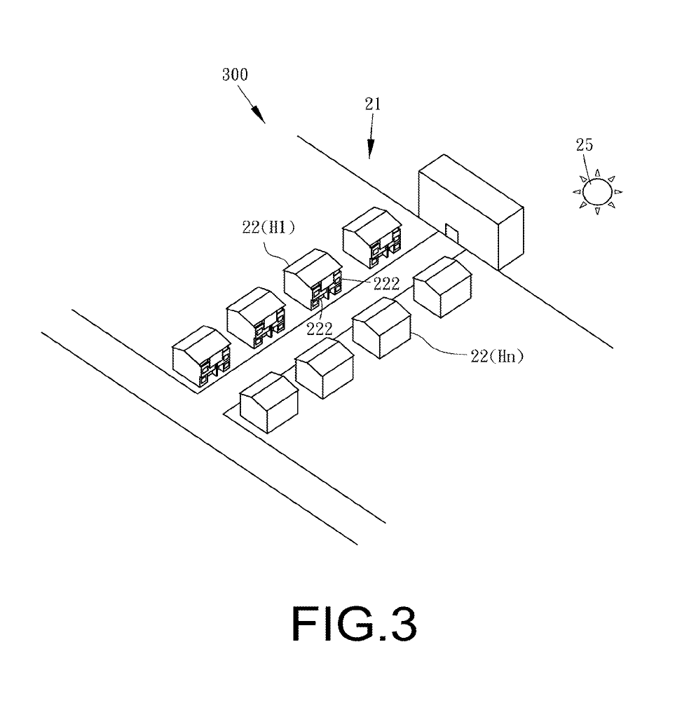

A storage module 20 is used to store an outdoor view model 21 (see FIG. 2), an indoor view model 22 (see FIG. 3), and a passage 222. The outdoor view model 21 includes nature and architectures such as rivers, seas, mountains, trees, flowers, hills, buildings, roads, traffic facilities, governments, schools, malls and supermarkets, which are partially or wholly compressed to form a 3D model compressed picture file to be stored in the storage module 20. The outdoor view model 21 is a 3D model. Alternatively, the outdoor view model 21 is a 2D model surrounding the indoor view model 22. The indoor view model 22 is a 3D model and comprises a plurality of objects each labeled as one of H1 to Hn representing a house such as one of house 21(H1) to house 21(Hn) as shown in FIG. 3. The houses 21(H1) to 21(Hn) are stored in the storage module 20. As shown in FIG. 3, each indoor view model 22 has a passage 222 open onto the outdoor. Details such as rooms of a house and shapes of a house are contained in each indoor view model 22. Further, furniture items 221 and other household items are contained in each indoor view model 22. The interior space and exterior shape of the house, and all the furniture 221, including the decorations, are all constructed and stored as a compressed picture file. The passage 222 can be a window or a door, and also stored as 3D model compressed picture file. The compressed picture files of the above mentioned outdoor view model 21, the indoor view model 22, and the passage 222, are integrated/combined and further stored in the storage module 20. The indoor view model 22 is disposed inside the outdoor view model 21, and the passage 222 is disposed in the indoor view model 22 for intercommunicating the indoor view model 22 and the outdoor view model 21. The compressed picture file mentioned in the present application is preferably FBX file. The size information of the outdoor view model 21, the indoor view model 22, and the passage 222 are constructed as three dimensional models (3D models), and those 3D models are further compressed by means of 3D image compression technology to store the material, size, scale of those 3D models as scene nodes. Different types of the data will be stored as virtual node by organizing the data in tree structure, thereby minimizing the energy consumption and saving the storage space. The size of the above mentioned outdoor view model 21, the indoor view model 22, and the passage 222 can be obtained by measuring, taking photos, or any predetermined value. The storage module 20 is implemented as a memory of a file server or cloud storage.

An input module 30 is an input device used to provide data and control signals to, for example, a computer. The input module 30 is implemented as a touch screen, a keyboard, a computer mouse, or an audio and video input device. The input module 30 can be incorporated into the output module 10 if the input module 30 is a touch screen. The control signals are used to, but not limited to, show, rotate, or move the image, move a model or an object, move an individual, open a door, close a door, open a window, close a window, restrict conditions of a house, and select a desired house.

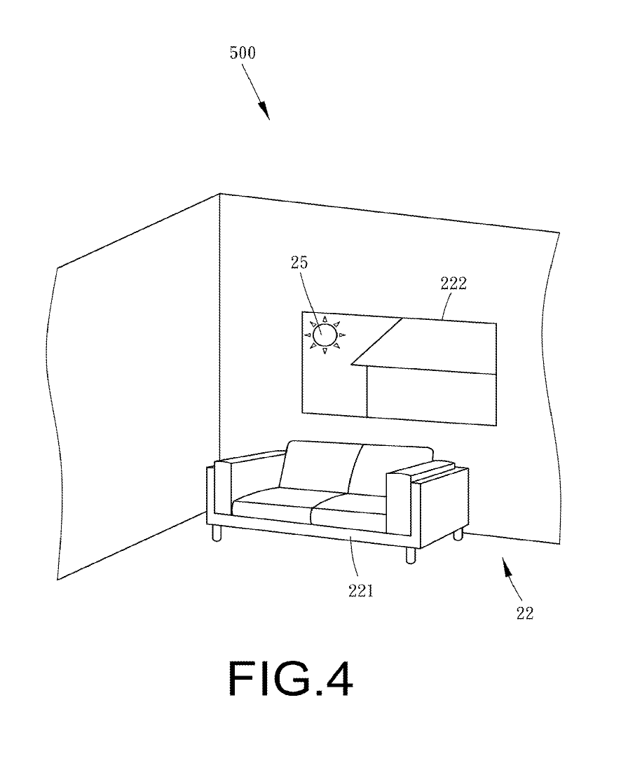

A processing module 40 is used to carry out instructions by performing the basic arithmetic, logical, control and input/output specified by the instructions. For example, the processing module 40 can read data from the outdoor view model 21, the indoor view model 22, and the passage 222 and activate same, and show the results on the output module 100. The processing module 40 executes the input command to show continuous motion or static images of the outdoor view model 21, the indoor view model 22, or the passage 222. A user-controlled virtual buyer can enter the indoor view screen 500 from the outdoor view screen 300 via the passage 222, or vice versa. Therefore, the present system not only can show the continuous motion images, but can also show the static image that the virtual buyer stays in the passage 222, the outdoor view screen 300 (FIG. 3), or the indoor view screen 500 (FIG. 4). The processing module 40 executes the input command to update the static image of the outdoor view screen 300 and the indoor view screen 500, and each static image can be moved according to the instruction of the command inputted by the user. Even more, the user can walk into or observe the indoor view screen 500 from the outdoor view screen 300, or from the outdoor view screen 300 into the indoor view screen 500 by seeing through the passage, such as a window. Therefore, as shown in FIG. 4, a user can see at least part of the outdoor view screen 300 from the indoor view screen 500, and the indoor view screen 500 shown in the indoor view model 22 can be rotated or shown by the control signal/command given by the user, and thus each detail portion of the interior of the house can be clearly seen. Furthermore, the processing module 40 of the preferred embodiment in the present invention includes a central processing unit (CPU) to execute the functions of calculating, processing, activating, moving, and rotating image.

As shown in FIG. 4, the indoor view model 22 is shown with an indoor view screen shown. A person in the house may see the sun and outdoor scenes through the passage 222 which is implemented as a window. Each object in the indoor view model 22 can be rotated by executing computer instructions so that details of the desired object can be seen clearly.

A potential buyer may operate the input module 30 to input query terms. The processing module 40 may process the terms with respect to a chosen property such as the indoor view model 22 labeled H1 (i.e., house 22(H1)). Further, the processing module 40 may read data, activate and process both the outdoor view model 21 and the indoor view model 22 with respect to the house 22(H1). As a result, the purpose of enabling an interested buyer to see a house by using the virtual system of the invention is obtained. In the present embodiment, since the indoor view model 22 is disposed inside the outdoor view model 21, the switching between the indoor view screen 500 and the outdoor view screen 300 is a continuous process, which means there is no image loading delay when the virtual buyer enters the house (indoor view screen 500) from outside of the house (outdoor view screen 300), or vice versa. Therefore, the present system can maximize the stimulated visual experience of seeing the house and the surrounding environment in person, and the buyer can see the interior or exterior of the house in any angles from any positions on the ground of the 3D indoor view module 22 and the 3D outdoor view module 21.

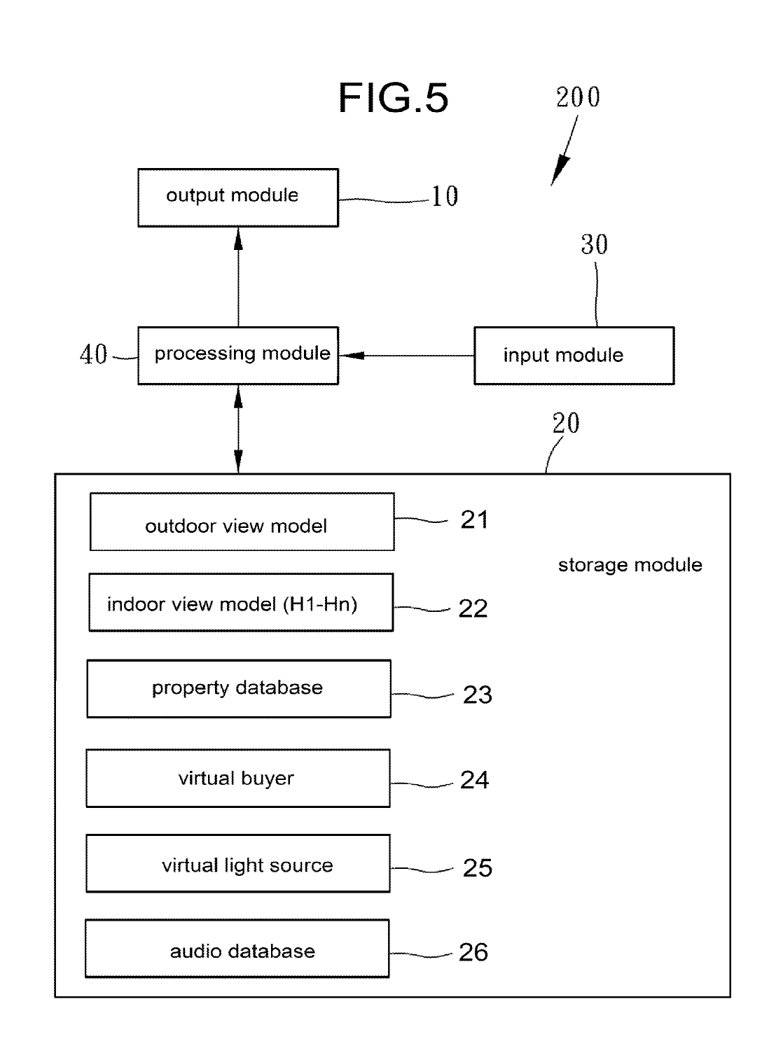

Referring to FIG. 5, a virtual system 200 for enabling an interested buyer to see a house prior to buying in accordance with a second preferred embodiment of the invention is shown. The characteristics of the second preferred embodiment are substantially the same as that of the first preferred embodiment except the following.

The storage module 20 further comprises a property database 23, a virtual buyer 24, a virtual light source 25, and an audio database 26. In detail, the property database 23 contains data including years, area, and conditions of a house, and surrounding environment such as parks, schools, governments, public facilities, rivers, lakes, etc. The processing module 40 may read data from the indoor view model 22 and activate same and at the same time the processing module 40 may access the property database 23. The accessed data is sent to the output module 10 for display.

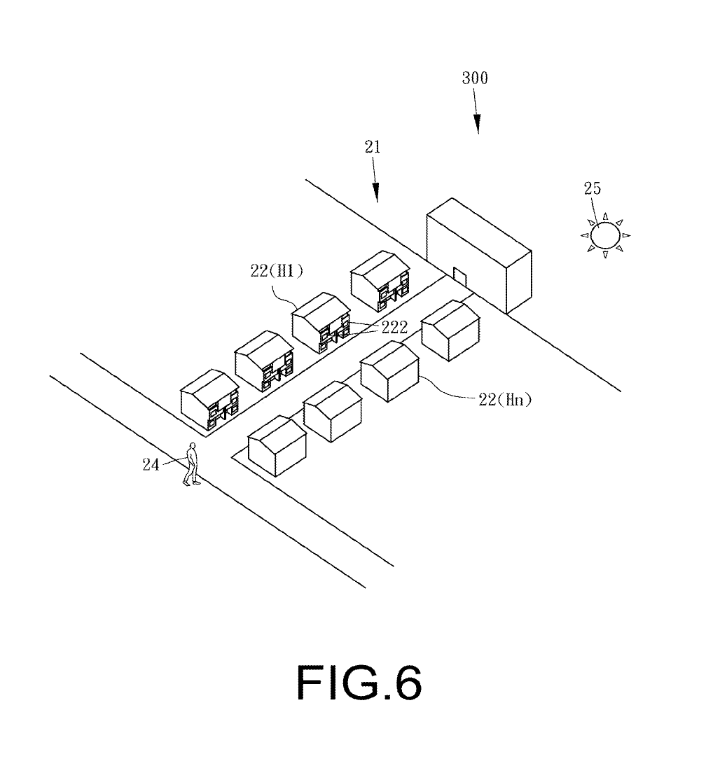

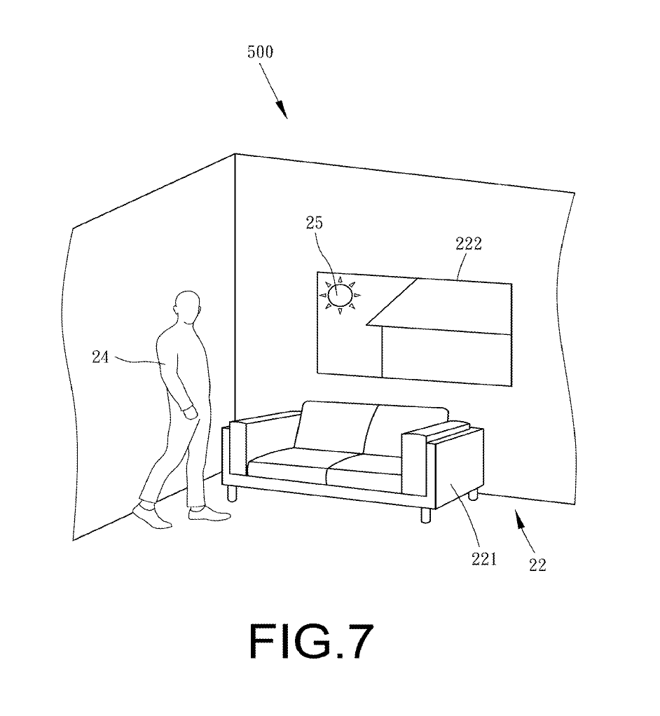

The virtual buyer 24 is stored in the storage module 20 in 3D model compressed FBX file format. The 3D model compressed file of the virtual buyer 24 is integrated with the outdoor view model 21, the indoor view model 22, and the passage 222. The processing module 40 may read data from the storage module 20 to access the virtual buyer 24. And in turn, the processing module 40 may move the virtual buyer 24 to simulate a potential buyer who walks from a road into a house to see interior of the house as shown in FIGS. 6 and 7. In FIG. 7, the virtual buyer 24 may walk in the house to see interior thereof and the potential buyer may determine whether a piece of furniture 221 may interfere with a walking path or not by watching the movements of the virtual buyer 24. The processing module 40 reads and executes the input order of the input module 30 to move the virtual buyer 24 from the indoor view model 22 via the passage 222 to the outdoor view model 21, and the virtual buyer 24 can observe the outdoor view screen 300 in the first-person perspective. In FIG. 6, the virtual buyer 24 may walk on the street to see surrounding environment of the house 22(H1) or the house 22(Hn). The surrounding environment is constructed by the outdoor view model 21. The implementations shown in FIGS. 6 and 7 are very close to seeing a property by a potential buyer in person. The method of constructing the 3D model of the virtual buyer 24 is the same as that of constructing the 3D model of the indoor view model 22, both of which are stored as FBX compressed files, and is thus not repeated hereinafter.

By storing those measured or default sizes of the 3D models in FBX file format, and combining those FBX files as a single image, the user can change the location of the virtual buyer 24 in the image by using input device, and the virtual buyer 24 can be moved to the indoor view screen 500 or the outdoor view screen 300 by penetrating through the physical passage 222. Changing the location of the virtual buyer 24 in the image is achieved according to the following formula: rb.MovePosition(transform.position+transform.forward*Time.deltaTime). When the user inputs a moving command, the CPU will calculate the moving of the virtual buyer 24 in each frame according to the above mentioned formula, and the calculated result will be shown through the output module 10. Since the model is constructed as 3D structure, the virtual buyer 24 can be operated by the user to start from the outdoor view screen 300, via the passage 222, to the indoor view screen 500, in a continuous motion without any image loading delay. In the meantime, the virtual buyer 24 can still observe portions of the outdoor view screen through the passage 222 when locating in the indoor view screen, and vice versa.

The virtual light source 25 is used to simulate sunlight or moonlight. The virtual light source 25 is stored in the storage module 20. The processing module 40 may read data from the storage module 20 to access the virtual light source 25. And in turn, the processing module 40 may move the virtual light source 25 which in turn may emit light onto the outdoor view model 21 (see FIG. 6). Alternatively, the light may illuminate the indoor view model 22 through the passage 222 (i.e., window) as shown in FIG. 7. It is envisaged by the invention that the virtual light source 25 may illuminate interior of a house 24 hours a day by simulating the sun or the moon. Therefore, a potential buyer may easily understand illumination within a house. The present embodiment adopts a rendering technique which mainly uses the existing instant light system to set up the environment variable and render the object by Standard Shader to simulate the light effect. The parameter is further calculated by the GPU in the processing module 40, and the calculated results is shown via the output module 10, thereby stimulating the natural light or weather effect, and utilizing the input module 30 to change the location of the light source 25 in the 3D model to illuminate objects and generate shadows.

The audio database 26 is stored in the storage module 20. The indoor view model 22 is stored in one of records of the audio database 26 and the outdoor view model 21 is stored in another record of the audio database 26. The processing module 40 may read data from the storage module 20 to access the indoor view model 22 in the audio database 26. And in turn, the indoor view screen 500 is shown. Also, the processing module 40 reads audio data from the audio database 26 and converts the data into audio signals. The audio signals are presented in a form of audible introduction of years, area, and conditions of a house.

Similarly, the processing module 40 may read data from the storage module 20 to access the outdoor view model 21 in the audio database 26. And in turn, the outdoor view screen 300 is shown. Also, the processing module 40 reads audio data from the audio database 26 and converts the data into audio signals. The audio signals are presented in a form of audible introduction of surrounding environment such as roads, parks, schools, governments, public facilities, rivers, lakes, etc.

It is envisaged by the invention that the virtual system enables an interested buyer to clearly see a house and fully understand both indoor and outdoor details of the house by not visiting the house in person prior to making a correct choice of buying a house.

Although the present invention has been described with reference to the foregoing preferred embodiments, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A virtual system for enabling a potential buyer to see a house, comprising:
an output module for presentation of images, text, video, and audio transmitted electronically;
an input module for inputting commands;
an outdoor view model, stored as an outdoor view 3D model compressed file;
an indoor view model, stored as an indoor view 3D model compressed file;
a passage, stored as a passage 3D model compressed file;
a storage module, wherein the outdoor view 3D model compressed file, the indoor view 3D model compressed file, and the passage 3D model compressed file are integrated to be stored in the storage module; the indoor view model being disposed inside the outdoor view model; the passage being disposed in the indoor view model and intercommunicating the indoor view model and the outdoor view module;
a processing module for reading and executing the indoor view model, the outdoor view model, and the passage, and the indoor view model, the outdoor view model, and the passage being shown by the output module; the processing module executing an input command from the input module to demonstrate a continuous motion image or a static image of the outdoor view model, the indoor view model, or the passage, such that a user can enter inside of the indoor view model from the outdoor view model through the passage, or enter into the outdoor view model from the indoor view model through the passage.

2. The virtual system of claim 1, wherein the compressed files are FBX files.

3. The virtual system of claim 1, wherein size information of the outdoor view model, the indoor view model, and the passage are constructed as three dimensional models (3D models), and those 3D models are further compressed by means of a 3D image compression technology to store material, size, scale of those 3D models as scene nodes, and different types of data will be stored as virtual node by organizing the data in tree structure.

4. The virtual system of claim 1, further comprising a virtual buyer, the virtual buyer being stored in the storage module in a 3D model compressed FBX file format, and being integrated with the outdoor view model, the indoor view model, and the passage.

5. The virtual system of claim 4, wherein the processing module reads and executes the input command from the input module to move the virtual buyer from the indoor view model via the passage to the outdoor view model, and the virtual buyer is able to observe an image of the outdoor view model in first-person perspective, as well as realizing landscape surrounding the indoor view model.

6. The virtual system of claim 4, wherein the processing module reads and executes the input command from the input module to move the virtual buyer, and the virtual buyer is able to move between the outdoor view model and the indoor view model in a continuous motion way.

7. The virtual system of claim 4, wherein the virtual buyer moves in the 3D model according to the following formula:
rb.MovePosition(transform.position+transform.forward* Time.deltaTime).

8. The virtual system of claim 1, further comprising a virtual light source for simulating sunlight or moonlight wherein the virtual light source is stored in the storage module, the processing module is configured to read data from the storage module to access the virtual light source, and the processing module is configured to move the virtual light source which is configured to emit light onto the outdoor view model, and the light is configured to illuminate the indoor view model through the passage.

9. The virtual system of claim 8, further comprising adopting a rendering technique which mainly uses an existing instant light system to set up an environment variable and render the object by Standard Shader to simulate a light effect; the parameter of the environment variable being further calculated by a GPU in the processing module, and a calculated result is shown via the output module, thereby stimulating the natural weather effect.
